(19) United States
(12) Patent Application Publication
(10) Pub. No.: US 2010/0075153 A1
(43) Pub. Date: Mar. 25, 2010

(54) Catalyzed Isocyanate Adhesive System For Wood Composites

(76) Inventors: Jianwen Ni, Franklin, TN (US); Jay Tanzer, Franklin, TN (US)

Correspondence Address: WADDEY & PATTERSON, P.C., 1600 DIVISION STREET, SUITE 500, NASHVILLE, TN, 37203, US

(21) Appl. No.: 12/237,791

(22) Filed: Sep. 25, 2008

(51) Int. Cl. B32B 21/00; B05D 3/02; C08G 18/02

(52) U.S. Cl. 428/425.1; 427/385.5; 525/452

(57) ABSTRACT

An adhesive system for, inter alia, the manufacturing of wood composites, which includes a two part adhesive system with an isocyanate polymer and an isocyanate catalyst in an thermosetting resin.

### BACKGROUND OF THE INVENTION

1. Technical Field

The present invention relates to a catalyzed adhesive system that can be used in the manufacturing of wood-based composites such as oriented strand board, particle board, medium density fiberboard, and composite structural lumber. More particularly, the present invention provides an adhesive system with a faster cure rate than conventional wood adhesives.

2. Background Art

Wood composites have attracted considerable attention for use as alternatives to natural wood products as wood composites typically exhibit physical properties similar to natural wood lumber. Generally, wood-based composites include particle board, oriented strand board (OSB), wafer board, as well as medium density fiberboard (MDF), with the wood-based composites typically formed from a wood material combined with a thermosetting or heat curing resin or adhesive to bind the wood substrate together. Generally, the resin or adhesive includes the use of an isocyanate polymer and aldehyde based adhesives. Depending on the type of wood composite and expected use for the wood composite, different resins are selected based upon strength and bonding properties with each adhesive having specific processing requirements including curing temperature and press time. In order to provide an improved wood composite or increasing the efficiency of producing a composite wood product, a variety of different adhesive systems have been developed.

For example, in Sleeter et al., U.S. Pat. No. 5,942,058, an adhesive system including a fast-setting resin such as polymeric isocyanates and a co-adhesive such as a drying oil is mixed with fibers for binding composite panels including OSB, and particle board plywood, as well as for other types of wood composites. According to Sleeter et al., the drying oil comprises an internal release agent that allegedly prevents the composite panel from sticking to the press utilized in forming the wood composite.

In Berube et al. (U.S. Pat. No. 6,569,801), an adhesive made from a liquid catalyst cross-linked with an amino resin which is comprised of a cross-linkable polyvinyl acetate, acid and an amino salt is disclosed. The catalyst is assertedly a liquid and provides both bond strength and water resistance to the adhesive substance typically being comprised of a copolymer, an acid, and an ammonium salt with a suggested storage life of at least three months.

In U.S. Pat. No. 6,297,313 issued to Hsu, an adhesive system is described including an aldehyde resin and polymeric isocyanate where the adhesive system preferably comprises a sprayable emulsion. More specifically, the combined aldehyde resin and polymeric isocyanate composition is generally described as having an average viscosity of not more than about 500 cps so that the resin is sprayable for use in creating wood composites.

Matuana et al., U.S. Pat. No. 6,702,969 discloses a method of making a wood-based composite board with a higher thermal conductivity than other wood-based composites with the composites of the '969 patent described as including fillers such as synthetic graphite, metal, carbon, and other similar compounds. Generally, thermoset resins are utilized with the method of the Matuana et al. patent typically utilizing phenol formaldehyde resin as well as urethane resins.

Gres describes an adhesive system in U.S. Pat. No. 7,064,175. the Gres system consists of powdered tannins and one or both of aldehyde polymers and polymeric isocyanate. Tannin is derived from renewable resources such as trees and plants. It was found that tannins may be used in dry form and provide adhesion without any externally added formaldehyde. It is further asserted by Gres that the disclosed adhesive system achieves better performance than the prior art aldehyde-containing adhesive formulations.

In U.S. Pat. No. 6,886,618 issued to Foucht et al., a system for the catalyzation of thermoset resin adhesives is disclosed that is asserted to provide feedback to adjust the curing by the controlled addition of a catalyst to the resin used to bond the wood substrate to form a wood composite. Generally, the system involves multiple feedback loops and specific resin and catalyst flow rates to vary, on a continuous basis, the proportion of the catalyst added during the process for making a wood composite.

Chen et al., U.S. Pat. No. 7,071,248 describes adhesive compositions that include polyisocyanate resins and adhesive additives for use in the manufacture of composite wood products. Generally, the adhesive additives comprise castor oil and one or more triglycerides with the additions allegedly improving cross-link density and also reducing the viscosity of the adhesive composition.

With the extensive use of wood composites, there exists a further need to provide an adhesive compound which allows manufacturers to press wood-based composite panels at a faster line speed and/or under lower press temperature and/or higher moisture tolerance. The prior art adhesive systems available do not provide for sufficiently fast line speed or pressed temperature conditions required for such manufacturing applications. Furthermore, the prior art adhesive systems do not provide for decreased mill emissions as higher press temperatures systems typically result in increased mill emissions.

What is desired, therefore, is a catalyzed adhesive system which provides a faster cure rate than prior art wood adhesives where the faster adhesive cure rate of the adhesive system makes the adhesive system ideally suited for use with a faster line speed and lower press temperature process. Indeed, a combination of characteristics including a two-part adhesive system with a combined catalyst resin mixture not seen in the prior art has been found to be necessary for the manufacturing of wood composite materials with improved processing conditions. Also desired is an adhesive system which may be utilized in conventional, hot press, steam injection press, RF microwave, or any other press technology.

### SUMMARY OF THE INVENTION

The present invention provides an adhesive system which is uniquely capable of improving the process for creating wood-based composite materials. The inventive adhesive exhibits a faster cure rate than conventional wood adhesives utilized in forming wood-based composite materials and specifically provides a faster cure rate at lower press temperatures not heretofore seen. In addition, the use of the novel adhesive system may provide for lower press temperatures and higher moisture pressing which may further reduce mill emissions resulting from the formation of wood-based composites.

Generally, wood-based composites created with the use of the novel adhesive of the present invention utilize wood particles which may be generally described as lignocellulosic materials including hardwood, softwood, and combination of both as well as other lignocellulosic substrates. Lignocellulosic materials may be described as the biomass of plants, generally including cellulose, hemicellulose, and lignin. Most often, wood-base composites such as fiberboard and particle board are produced from lignocellulosic particles bonded with an adhesive and may also be formed from lower grade wood materials as well as lignocellulosic waste created in other wood product production.

An additional class of wood composite materials includes oriented strand board (OSB) which comprises layers of thin lignocellulosic strands, generally wood particles having a length several times greater than their width. In forming OSB with the adhesive of the present invention, the strands are generally positioned relative to each other with their length having a substantial parallel orientation generally parallel to the edge of one of the layers. Further description of the details of the specific orientation of the lignocellulosic strands including desirable layering and positioning are described in U.S. Pat. No. 3,164,511; U.S. Pat. No. 4,364,984; U.S. Pat. No. 5,435,976; U.S. Pat. No. 5,470,631; U.S. Pat. No. 5,525,396; and U.S. Pat. No. 5,718,786, the disclosures of each of which are incorporated herein by reference in their entirety.

The novel adhesive system used in forming the wood-based composite material may be described as an adhesive composition having a first adhesive and a second adhesive. Preferably, the first adhesive system comprises an isocyanate, in particular MDI polymers. Generally, the polymeric isocyanate comprises an organic isocyanate polymer compound having at least about two active isocyanate groups per molecule or mixtures of such compounds.

The second adhesive of the adhesive system of the present invention may generally be described as a thermosetting resin, and is preferably an aldehyde-containing adhesive having an isocyanate catalyst mixed there within. Preferably, the aldehyde-containing adhesive acts as a carrier for the isocyanate catalyst. This aldehyde-containing adhesive carrier may generally comprise resins such as urea-formaldehyde, melamine urea-formaldehyde, phenol-formaldehyde, melamine-urea-phenol-formaldehyde, combinations thereof as well as other aldehyde-containing adhesives.

The catalyst maintained within the second adhesive is preferably water soluble or emulsifiable so that the catalyst may be mixed within the aldehyde-containing adhesive. Preferably, the catalyst is fairly evenly distributed in a near homogeneous distribution. Furthermore, the catalyst may include any isocyanate catalyst that may be used to promote isocyanate reactions.

The two parts of the adhesive system may be applied separately or in a premixed arrangement to the lignocellulosic material in forming the wood-based composite structure. Preferably, separate application is preferable to improve the adhesive stability and also reduce possible resin line plugging in the manufacturing of a wood-base composite material. As such, the adhesive composition may be applied in any conventional method to the lignocellulosic material in forming the wood-base composite.

Advantageously, in manufacturing a wood-based composite using the novel adhesive, an adhesive system is provided with a first adhesive comprising at least one isocyanate resin and a second adhesive comprising an aldehyde-containing resin carrier with a dispersed isocyanate catalyst. Both adhesives are applied to the lignocellulosic material and subsequently the mixture is exposed to an elevated temperature and pressure to form the wood composite material.

An object of the invention, therefore, is a method of manufacturing a wood composite which requires a lower press temperature in the manufacturing process.

Yet another object of the invention is a method of manufacturing a wood-based composite where the adhesive utilized in the manufacturing provides a faster cure rate than conventional wood adhesives.

Still another object of the invention is a wood composite including a cured polyisocyanate adhesive that is catalyzed by an isocyanate catalyst dispersed within an aldehyde-containing resin carrier.

Yet another object of the invention is an adhesive system for use in creating wood-based composites requiring less activation energy for the curing of the adhesive.

These aspects and others that will become apparent to the artisan upon review of the following description can be accomplished by providing a lignocellulosic material and an adhesive system comprised of a first adhesive including isocyanate resins and a second adhesive comprising an isocyanate catalyst dispersed within an aldehyde-containing resin. The inventive adhesive system advantageously requires less activation energy in forming the wood-based composite material. As such, lower press temperatures or times are required in the manufacturing of a wood-based composite utilizing the adhesive of the present invention.

It is understood that both the foregoing general description and the following detailed description, especially when read in light of the appended drawings, provide embodiments of the invention and are intended to provide an overview of framework of understanding to nature and character of the invention as it is claimed.

### BRIEF DESCRIPTION OF THE DRAWINGS

FIG. 1 is a DSC Scan of various MDI combinations.

FIG. 2 is a DSC Scan of the adhesive system of the present invention with varying amounts of the dispersed catalyst.

FIG. 3 is a DSC Scan of the adhesive system of the present invention with varying amounts of the dispersed catalyst.

FIG. 4 is a DSC Scan of the adhesive system of the present invention with varying amounts of the dispersed catalyst.

FIG. 5 is a DSC Scan of the adhesive system of the present invention with varying amount of the dispersed catalyst.

FIG. 6 is a graph of the internal bond strength achieved with practice of the present invention, as compared to conventional processes.

### DETAILED DESCRIPTION OF THE PREFERRED EMBODIMENTS

Wood composites in accordance with the present invention are prepared from lignocellulosic materials and the novel adhesive system. The term “wood composite” is used herein to describe composites known as particle board, chip board, wafer board, fiber board, and oriented strand board wherein the board substrate is prepared by application of the adhesive system to the lignocellulosic material including particles, chips, fibers, specifically wood particles, wood chips, and lignocellulosic fibers and subsequently formed into the desired board through application of heat and pressure. Further detail concerning lignocellulosic materials which may be utilized in forming wood composites is described in U.S. Pat. No. 6,297,313 issued to Hsu, which is hereby incorporated by reference in its entirety. Additionally, the method and product of the present invention and its advantages over the prior art, can be realized with the respect to a wide variety of lignocellulosic substrate materials, and as such, may be used with a wide variety of particle type and form.

Generally, the process of creating a wood-based composite involves the consolidation or joining together of lignocellulosic materials using pressure, heat, and adhesive. The adhesive system as described herein is useful for a wide variety of wood composites and is particularly useful in forming board-shaped wood composites for use in industrial applications. Advantageously, the adhesive system of the present invention can be utilized in multiple types of press arrangements including conventional hot press, steam injection press and RF microwave-type pressing.

In forming a wood-based composite with the adhesive system in accordance with the present invention, a substrate of lignocellulosic material is selected based upon the desired type of wood composite. Typically, such substrates include wood particles derived from wood and wood residues such as wood chips, wood fibers, shavings, veneers, wood wool, cork, bark, sawdust, as well as other wood-based materials. Particles of other lignocellulosic materials including shredded paper, pulp, vegetable fibers such as corn stalks, straw, bagesse, and combinations thereof which also be utilized. Additives may also be combined to form wood products with the adhesive system to provide wood-based composites with a variety of characteristics. These additives may include various rubber and polymer elements as well as additives to impart fire retardancy, conductivity, or any other desirable characteristic for the composite.

Wood-based composites of the present invention may be produced by bonding together lignocellulosic materials by using heat, pressure, and the adhesive system of the present invention. The invention particularly relates to a use of an adhesive system wherein the lignocellulosic material is contacted with a two-part adhesive and subsequently formed into wood-based composites by the application of heat and pressure to cure the adhesive and form the wood-based composite. Wood-based composites of the present invention using the two-part adhesive system may include wafer board, particle board, plywood, oriented strand board, medium density fiber board, and the like.

The adhesive system of the present invention comprises a two-part system. The first part (Part One) of the adhesive system may generally be described as an isocyanate polymer with the second part (Part Two) comprising an isocyanate catalyst admixed with and carried by an aldehyde-containing adhesive. The two parts of the adhesive system may be applied separately to the lignocellulosic material or premixed and applied to the lignocellulosic material. Preferably, the separate application of Part One of the adhesive system and Part Two of the adhesive system to the lignocellulosic materials is conducted which results in improved adhesive stability as the adhesive system is not mixed prior to contact with the lignocellulosic material. The separate application of the adhesive parts may reduce resin line plugging and blender buildup as there is less likelihood of curing of the adhesive system prior to the application of the adhesive system to the lignocellulosic material in forming the wood composite.

The isocyanate polymer of Part One of the adhesive system may suitably be any organic isocyanate polymer compound containing at least 2 active isocyanate groups per molecule, or mixtures of such compounds. The isocyanate polymer used in the present invention may also be referred to as isocyanate resins or polyisocyanates with the terms used interchangeably herein. The functionality of the isocyanate polymers is of at least about two and preferably ranges from 2.3 to 3.5. Typically, the isocyanate polymer of Part One is referred to as an MDI adhesive.

Furthermore, the isocyanate polymers can be those that are typically employed in adhesive compositions, including typical aromatic, aliphatic and cycloaliphatic isocyanate polymers. Representative aromatic isocyanate polymers are discussed in U.S. Pat. No. 4,209,433, the disclosure of which is hereby incorporated by reference in its entirety. Part One of the adhesive system may include 2,4-tolylene diisocyanate, 2,6-tolylene diisocyanate, 4,4′-methylene bis(phenyl isocyanate), 1,3-phenylene diisocyanate, triphenylmethane triisocyanate, 2,4,4′-triisocyanatodiphenyl ether, 2,4-bis(4-isocyanatobenzyl)phenylisocyanate and related polyaryl polyiscocyanates, 1,5-naphthalene diisocyanate and mixtures thereof. Representative aliphatic isocyanate polymers include hexamethylene diisocyanate, xylylene diisocyanate, 1,12-dodecane diisocyanate and lysine ethyl ester diisocyanate. Representative cycloaliphatic isocyanate polymers include 4,4′-methylenebis(cyclohexyl isocyanate), 1,4-cyclohexylene diisocyanate, 1-methyl-2,4-cyclohexylene diisocyanate and 2,4-bis(4-isocyanatocyclohexylmethyl)cyclohexyl isocyanate.

Part Two of the adhesive system of the present invention includes a thermosetting resin, especially an aldehyde-containing resin, with a catalyst for curing the isocyanate polymer. Generally, the aldehyde-containing adhesive includes urea-formaldehyde, melamine-formaldehyde, melamine-urea-formaldehyde, phenol formaldehyde, and melamine-urea-phenol-formaldehyde among others. Generally, aldehyde-containing resins are created through a condensation reaction of an aldehyde, preferably formaldehyde, with a compound containing an amino or phenolic group. Preferably, formaldehyde is utilized in forming the amino resin though other aldehydes may also be used including acetaldehyde, propionaldehyde, furfuraldehyde, benzaldehyde, and as well as combinations thereof. Preferably, the aldehyde-containing resins have a molar ratio of formaldehyde to the amino in a range of from about 0.5:1 to about 1.5:1 for use as the amino resin carrier of Part Two of the adhesive system.

The isocyanate catalyst included in Part Two of the inventive adhesive system includes any isocyanate catalyst for promoting the reaction of the isocyanate polymer of Part One of the adhesive system. While aldehyde-containing resins may exhibit some catalytic activity when mixed with isocyanate polymers, the term catalyst, as used herein, refers to an additional compound for providing a faster cure rate, or requiring less energy input than conventional adhesives used in forming wood-based composites. Specifically, isocyanate catalysts for Part Two of the adhesive system of the present invention may include isocyanate catalysts known to the skilled artisan and include those commercially available under the tradenames Dabco 33-LV®, comprising a solution of 33% triethylenediamine and 67% dipropylene glycol, Polycat® SA-1 and Polycat® SA-102, both of which are based on 1,8 diaza-bicyclo(5,4,0) undecene-7, and Polycat® 17, comprising trimethyl-n′,2-hydroxyethyl-propylenediamine, among other catalysts which may include amino alcohols. Preferably, the isocyanate catalyst is water soluble or emulsifiable so that the catalyst may be mixed within the aldehyde-containing resin of Part Two of the adhesive system. The total weight percent of the catalyst within the adhesive system preferably comprised from about 0.1% to about 10% of the total weight of the adhesive system. Furthermore, the isocyanate catalyst should preferably be dispersed within the aldehyde-containing resin to provide for the proper curing of the adhesive system upon combination with Part One.

The adhesive system of the present invention may be applied to the lignocellulosic materials through standard application techniques. Preferably, the adhesive is applied in a two-step process so that the isocyanate catalyst and aldehyde-containing resin are combined with the isocyanate resin in the presence of the lignocellulosic material. The fabrication of a wood-based composite of the present invention involves the application of the two-part adhesive composition to the lignocellulosic particles with the subsequent application of heat and pressure to form the wood composite in its desired configuration. Furthermore, the adhesive system may be applied through a variety of conventional means including spray coating so that the adhesive is substantially evenly distributed among the lignocellulosic material.

To further illustrate the principles and operation of the present invention, the following examples are provided. However, these examples should not be taken as limiting in any regard.

### Example 1

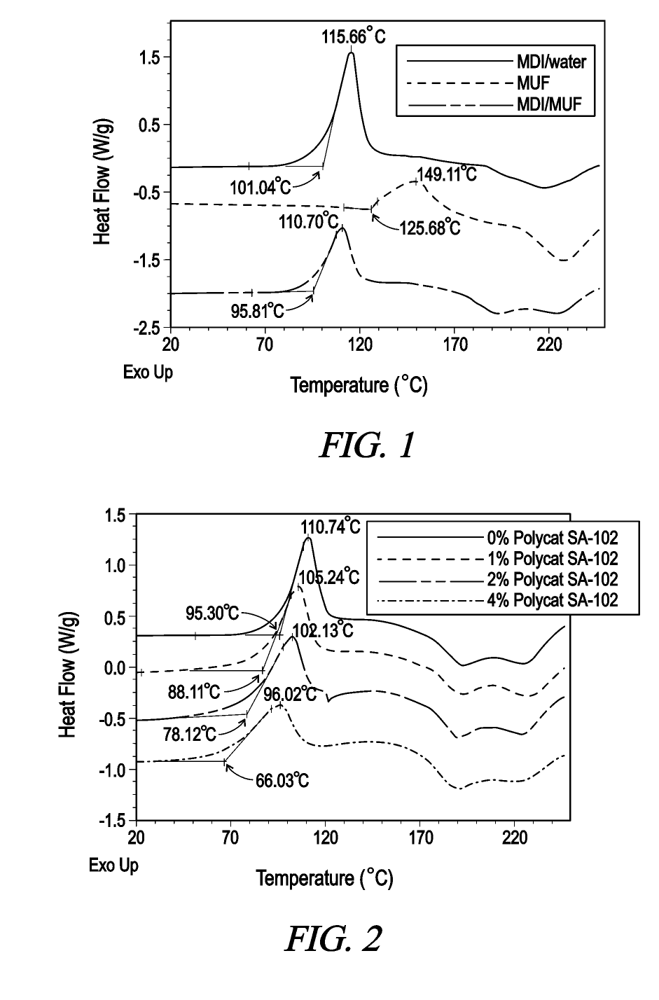

FIG. 1 illustrates a Differential Scanning Calorimetry (DSC) Scan for the combinations of methylene diphenyl diisocyanate (MDI) with water, MDI and urea formaldehyde and MDI and melamine-urea-formaldehyde. The graph illustrates that the MDI/MUF combination cures at a lower temperature than either MDI alone or MUF alone. This graph generally demonstrates the curing of an adhesive system, an isocyanate polymer and an amino resin, though notably, does not include an isocyanate catalyst as does the adhesive system of the present invention.

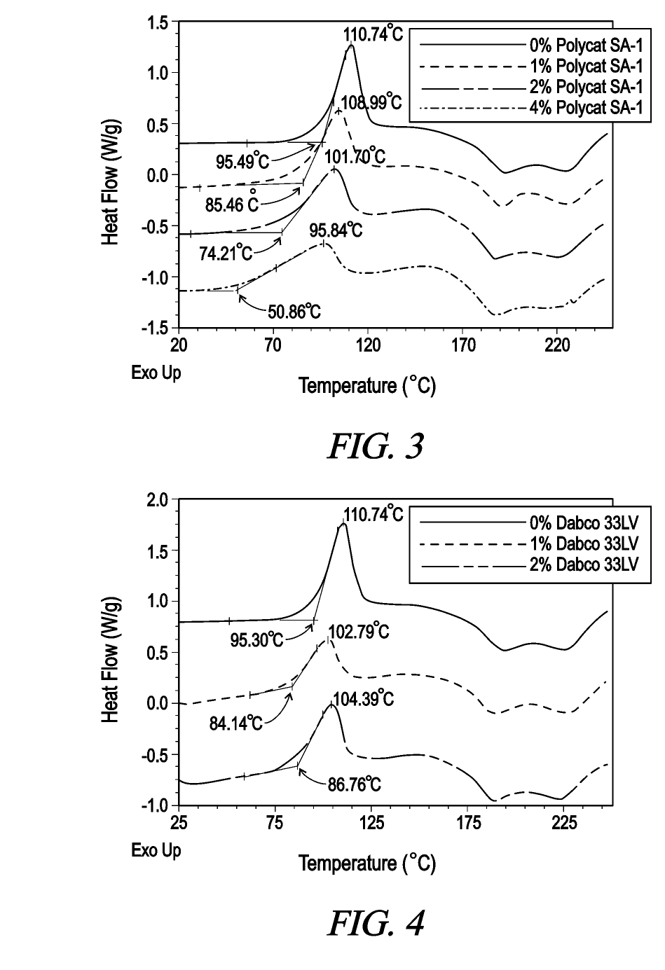

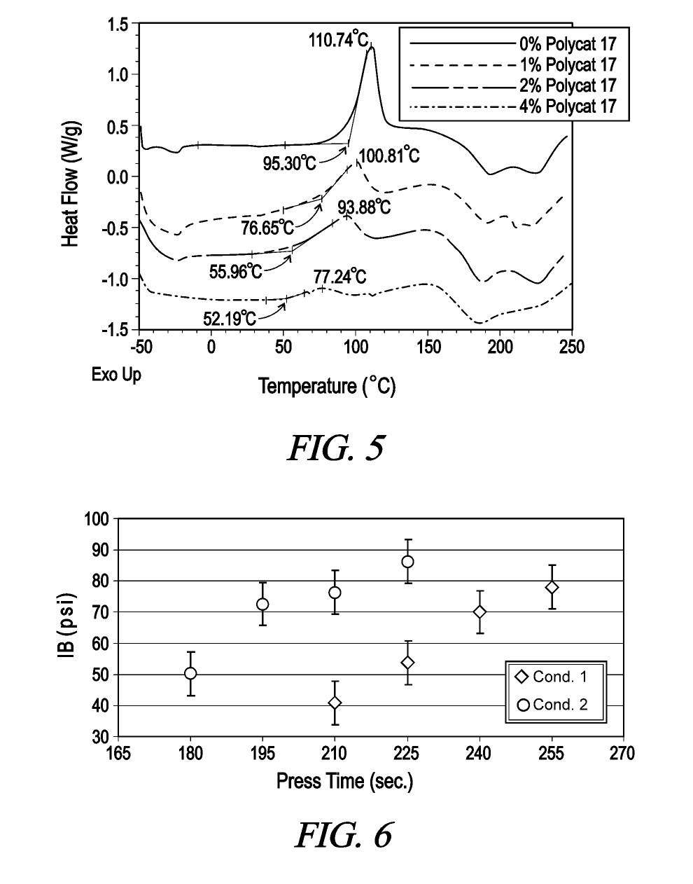

Referring now to FIG. 2-5, there are graphs of DSC Scans demonstrating the effects of various catalysts on the cure rate of the adhesive system of the present invention. In each of the adhesive systems containing zero percent catalyst, the corresponding curve is almost identical to the MDI/MUF combination in FIG. 1 as would be expected. With the increasing amount of catalyst added to the MDI/MUF combination, a lower reaction temperature for the curing of the adhesive can be realized. For example, in FIG. 3, catalyst Polycat® SA-1 is incorporated in different percentages into the amino resin MUF for combination with the isocyanate resin MDI, with the 4% Polycat® SA-1 adhesive system displaying the lowest cure temperature followed by the 2% Polycat® SA-1 adhesive system followed by the 1% Polycat® SA-1 adhesive system with the MDI/MUF combination without an isocyanate catalyst requiring the greatest temperature for curing.

As can be surmised from FIGS. 2-5, the addition of greater percentages of an isocyanate catalyst results in an increased drop in required temperature for the curing of the adhesive system of the present invention. Catalysts Polycat® SA-102, Polycat® SA-1, Dabco® 33LV, and Polycat® 17, among many others may be used to provide for favorable curing characteristics of the adhesive system of the present invention. The use of the aforementioned catalysts should not be considered limiting in any regard, but instead, illustrate how an isocyanate catalyst may function with the present invention.

### Example 2

Three-layer strand boards are made as follows. The surface layers constitute 60% of the total board weight, while the core layer constitutes 40% of the weight. Southern Yellow Pine strands are obtained from an OSB mill. The strands are screened and dried to 9-11% moisture content, and then blended with a pMDI resin (with and without an accelerator) and a wax emulsion. Wax is added at 0.7% rate, based on oven-dried wood weight. The resin and accelerator application rates (based on oven-dried wood weight) are shown in Table 1. In condition 2, the core accelerator is a mixture of a MUF resin and a catalyst (Polycat® SA-102 from Air Products).

TABLE 1

| Condition # | Face Resin | Core Resin | Core Accelerator |
|---|---|---|---|
| 1 | 2% pMDI | 2% pMDI | None |
| 2 | 2% pMDI | 2% pMDI | 0.3% MUF w/ SA-102 |

The boards are pressed at 330° F. for various press time to a target density of 40 pcf and a target thickness of 23/32″. The boards are then tested for internal bond (IB) strength. The results are shown in FIG. 6. The results demonstrate that the addition of the MUF/SA-102 mixture significantly increases the cure speed of the resin system.

Accordingly, by the practice of the present invention, an adhesive system for creating wood-based composites having heretofore unrecognized characteristics is disclosed. This adhesive system comprising a first and second part provides for a significant decrease in the required temperature for the curing of the adhesive system, and thus advantageously allows for a decrease in the temperature or time necessary to form wood composites making such an adhesive system uniquely effective in the manufacturing of wood-based composites. The disclosure of all cited patents and publications referred to in this application are incorporated herein by reference.

The above description is intended to enable the person skilled in the art to practice the invention. It is not intended to detail all the possible variations and modification that are apparent to the skilled worker upon reading the description. It is intended, however, that all such modifications and variations be included within the scope of the invention that is defined by the following claims. The claims are intended to cover the indicated elements and steps that any arrangement or sequence that is effective to meet the objectives intended for the invention unless the context specifically indicate the contrary.

What is claimed is:

1. A method of manufacturing a wood composite comprising the steps of:
a) providing a first adhesive comprising at least one isocyanate polymer;
b) providing a second adhesive comprising a thermosetting resin with an isocyanate catalyst dispersed therein;
c) applying the first adhesive and the second adhesive to lignocellulosic material to form an adhesive lignocellulosic mixture;
d) curing the adhesive lignocellulosic mixture at a temperature and for a period of time to form the wood composite wherein the temperature and time for cure of the adhesive lignocellulosic mixture is less than that required for the same method without a dispersed isocyanate catalyst in the second adhesive.

2. The method of claim 1 wherein the isocyanate polymer comprises a polymer selected from the group consisting of 2,4-tolylene diisocyanate, 2,6-tolylene diisocyanate, 4,4′-methylene bis(phenyl isocyanate), 1,3-phenylene diisocyanate, triphenylmethane triisocyanate, 2,4,4′-triisocyanatodiphenyl ether, 2,4-bis(4-isocyanatobenzyl)phenylisocyanate and related polyaryl polyiscocyanates, 1,5-naphthalene diisocyanate, hexamethylene diisocyanate, xylylene diisocyanate, 1,12-dodecane diisocyanate, lysine ethyl ester diisocyanate, 4,4′-methylenebis, 1,4-cyclohexylene diisocyanate, 1-methyl-2,4-cyclohexylene diisocyanate, 2,4-bis(4-isocyanatocyclohexylmethyl)cyclohexyl isocyanate and combinations thereof.

3. The method of claim 1 wherein the thermosetting resin comprises an aldehyde.

4. The method of claim 3 wherein the thermosetting resin comprises formaldehyde, acetaldehyde, propionaldehyde, furfuraldehyde, benzaldehyde, and combinations thereof.

5. The method of claim 3 wherein the thermosetting resin comprises formaldehyde.

6. The method of claim 3 wherein the thermosetting resin comprises urea-formaldehyde, phenol formaldehyde, melamine-formaldehyde, melamine-urea-formaldehyde, and combinations thereof.

7. The method of claim 1 wherein the isocyanate catalyst comprises solutions of triethylenediamine and dipropylene glycol.

8. The method of claim 1 wherein the isocyanate catalyst comprises propylenediamine.

9. The method of claim 1 wherein the isocyanate catalyst comprises a catalyst based upon 1,8 diaza-bicyclo(5,4,0) undecene-7.

10. The method of claim 1 wherein the catalyst comprises an amino alcohol.

11. The method of claim 1 wherein the isocyanate catalyst comprises of from about 0.1% to about 10% of the combined weight of the first adhesive system and the second adhesive.

12. The method of claim 1 wherein the application of the first adhesive and the second adhesive of step c.) comprises the application of the first adhesive to the lignocellulosic material followed by the application of the second adhesive to the first adhesive lignocellulosic material combination to form the adhesive lignocellulosic mixture.

13. The method of claim 1 wherein the application of the first adhesive and the second adhesive of step c) comprises the application of the second adhesive to the lignocellulosic material followed by the application of the first adhesive to the second adhesive lignocellulosic material combination to form the adhesive lignocellulosic mixture.

14. The method of claim 1 wherein the lignocellulosic material comprises wood material.

15. The method of claim 1 wherein the lignocellulosic material is selected from the group consisting of wood chips, wood fibers, shavings, veneers, wood wool, cork, bark, sawdust, shredded paper, pulp, vegetable fibers, straw, bagesse, and combinations thereof.

16. A method of manufacturing a wood composite comprising the steps of:
a) creating an adhesive composition comprising a first adhesive of at least one isocyanate polymer combined with a second adhesive of a dispersed isocyanate catalyst in an aldehyde-containing resin;
b) combining the adhesive composition with lignocellulosic material to form an adhesive lignocellulosic mixture;
c) applying an elevated temperature and an elevated pressure to the adhesive lignocellulosic mixture to form the wood composite.

17. A wood composite comprising a lignocellulosic material and a cured adhesive, wherein the cured adhesive comprises a linked polymer that is a reaction product of a first adhesive of at least one isocyanate polymer and a second adhesive of a dispersed isocyanate catalyst in an aldehyde-containing resin.

18. The wood composite of claim 17 wherein the wood composite is selected from the group consisting of wafer board, particle board, plywood, oriented strand board, medium density fiber board, and combinations thereof.

19. An adhesive system for a wood composite comprising:
a first adhesive comprising at least one isocyanate polymer; and
a second adhesive comprising a dispersed isocyanate catalyst in an amino resin carrier
wherein the dispersed isocyanate catalyst provides for a reaction between the first adhesive and the second adhesive to occur at a lower temperature than for the same reaction without the dispersed isocyanate catalyst.

20. The adhesive of claim 19 wherein the isocyanate catalyst comprises of from about 0.1% to about 10% of the total weight of the adhesive system.
